(19) United States
(12) Patent Application Publication
(10) Pub. No.: US 2002/0192511 A1
(43) Pub. Date: Dec. 19, 2002

(54) Functional coating and method of producing same, in particular to prevent wear or corrosion or for thermal insulation

(76) Inventors: Martin Hruschka, Abstatt-Happenbach (DE); Ulrich Hasenkox, Ditzingen (DE); Guido Klamt, Gerlingen (DE)

Correspondence Address: KENYON & KENYON, ONE BROADWAY, NEW YORK, NY, 10004, US

(21) Appl. No.: 10/152,592

(22) Filed: May 20, 2002

(30) Foreign Application Priority Data
May 18, 2001 (DE) 101 244 34.7

(51) Int. Cl. B05D 3/02; B05D 3/06; B32B 9/04

(52) U.S. Cl. 428/704; 427/376.2; 427/558; 427/554

(57) ABSTRACT

A functional coating on a substrate, including an inorganic matrix phase composed as far as possible of a phosphate and a functional material embedded in it. In addition, a method of producing this functional coating whereby first at least one functional material is dispersed in a matrix solution including a liquid component and a phosphate, and the gelatinous dispersion thus produced is applied to the substrate in the form of a coating. Then this coating is converted by a heat treatment to the functional coating including the inorganic matrix phase and the functional material integrated into it. The functional coating described here is suitable e.g., for protection against wear or corrosion or for thermal insulation, e.g., in automotive engineering or in heating technology.

### FIELD OF THE INVENTION

The present invention relates to a functional coating on a substrate as well as a method of producing the functional coating.

### BACKGROUND INFORMATION

Wear and corrosion on materials often result in premature failure of components and equipment and thus cause considerable costs. To suppress these effects, a number of coatings for preventing corrosion and wear are conventional. These include coatings based on ceramic materials due to their high thermal stability, chemical stability with respect to corrosive media and high hardness.

For the production or deposition of ceramic coatings, a number of different methods are conventional such as sputtering, thermal spraying, detonation coating, CVD (chemical vapor deposition), PVD (physical vapor deposition) or the sol-gel method. A disadvantage of these methods is the high process temperatures in some cases, which may have negative effects on the properties of the base material, i.e., the coated substrate, and high process costs, which prevent wide-scale use, or complex coating technology, which does not allow mass production.

European Patent Application No. 0 302 465 describes a coating method in which a thin layer of aluminum phosphate is applied as an adhesive layer by chemical or electrolytic deposition to a metal surface and fired for 30 minutes at 150° C. Then a ceramic coating is produced by the usual coating methods on this high-temperature resistant adhesive layer. This yields a heat-resistant layer which protects the coated metal surface from oxidation.

The “composite sol-gel process” is referred to in Q. Yang and T. Troczynski, J. Am. Ceram. Soc., 82, (1999), pages 1928 to 1958, and J. Am. Ceram. Soc., 83, (2000), pages 958 to 960. In this method, the shrinkage of the sols in drying and subsequent sintering is greatly reduced by introducing ceramic particles as fillers into a sol-gel process. Thus, in contrast with the pure sol-gel process, deposition of thick layers, i.e., 10 μm to 500 μm thick, is possible in one process step. However, sintering at 1300° C. to 1400° C. provides for compaction and formation of ceramic bonds.

Finally, coatings of an Al(OH)₃ sol with ceramic particles as filler, applied to metal specimens by spraying or dipping and then drying at 300° C. to 500° C. are referred to in S. Wilson, H. Hawthorne, Q. Yang and T. Troczynski, “Sliding and Abrasive Wear of Composite Sol-Gel Alumina Coated Alumina Alloys,” submitted to Surface and Coatings Technology. In this process, the aluminum hydroxide, which is first dissolved in the coating, is at least partially converted to γ-Al₂O₃. Then in an independent process step, the porous layer produced initially is infiltrated with a phosphating bath so that some of the dry Al(OH)₃-sol/γ-Al₂O₃ mixture is converted to aluminum metaphosphate (Al(H₂PO₄)₃) by the phosphoric acid present in the phosphating bath and then is converted to insoluble and thermally stable aluminum phosphate (AlPO₄) by an additional heat treatment at 300° C. to 500° C. The aluminum phosphate thus produced in the functional coating acts as a binding matrix between ceramic particles and the surface of the metal.

It is an object of the present invention to provide a functional coating on a substrate and a method of producing such a functional coating which will have the widest possible scope of use, e.g., on metals or metal alloys such as steels, sintered metals or aluminum alloys in the fields of automotive engineering and mechanical engineering. It should be possible to deposit the coating on the substrate at the lowest possible temperatures and with the fewest possible steps, e.g., in just one process step, by using the simplest possible wet chemical process engineering. In addition, the properties of the coatings thus produced should be readily adaptable to the respective field of use.

### SUMMARY OF THE INVENTION

The method according to the present invention and the functional coating produced according to the present invention may provide the advantage that the coating may be produced on virtually any desired surfaces, e.g., metallic or ceramic surfaces, at low temperatures by simple wet chemical process engineering, the coating is producible in one process step which includes application, drying and firing or a heat treatment.

If necessary, it may be advantageously possible to perform an aftertreatment of the surface of the coating thus produced, e.g., directly after the heat treatment, and to integrate this aftertreatment into the method according to the present invention. This aftertreatment may be, for example, polishing or a subsequent introduction of an additional function into the functional coating, i.e., infiltration of graphite or a lubricant into a pore structure of the functional coating to reduce the coefficient of friction, for example.

Thus on the whole, a system of an inorganic binder matrix and a functional material bound in it or a mixture of functional materials is produced, the properties of the functional coating thus produced is very easily adaptable to desired property profiles by varying the functional material or the composition of the functional materials.

Finally, the separation of layer application and chemical binding of the layer produced first to the substrate, which is conventional, need not be performed in two separate steps with the method according to the present invention.

With conventional wet chemical processes for producing ceramic layers, binding of the layer to the underlying metal surface is either accomplished by a sintering operation, i.e., for example, a conventional sol-gel method with a subsequent heat treatment at high temperatures, by application of a chemically bound conversion layer or adhesion layer, which is applied prior to the production of the actual coating, or by applying a ceramic gel layer, which is transformed to the function layer in a subsequent, separate process step by a chemical reaction, e.g., with an infiltrated dilute phosphoric acid, and then firing. In the latter process variant, the properties of the functional coating thus produced may be adapted to the respective application only through the choice of the ceramic material, i.e., extensive targeted adaptation of the properties of the layer through a functional material introduced into it is not possible. These disadvantages are overcome by the method according to the present invention.

It may be advantageous that a ceramic coating may be applied to a metallic or ceramic substrate by the method according to the present invention, this metallic substrate is, for example, a steel, a sintered metal or an aluminum alloy.

In addition, it may be advantageous that the method according to the present invention is also suitable for coating components which may be exposed to temperatures only up to max. 500° C. due to their thermal sensitivity, or in the case of many workpiece steels, only up to max. 200° C.

It may be advantageous if the matrix phase of the functional coating thus produced is exclusively or almost exclusively an inorganic matrix phase of aluminum phosphate into which various functional materials, e.g., aluminum oxide or graphite, are embedded, depending on the application. Such function layers are applied to the coated substrate over water-based gels or dispersions of dissolved monoaluminum phosphate and powdered functional materials dispersed in it, then dried and fired in an oven at typical temperatures of 150° C. to 500° C., e.g., 200° C. to 400° C.

Another advantage of the functional coating thus produced and the method developed may be its greater flexibility with regard to possible areas of application, including improved protection against wear, reduction of the coefficient of friction, high-temperature corrosion protection, high thermal insulation and thermal insulation.

The functional coatings that have been developed are especially suitable for applications with moderate loads, i.e., for coatings on gear pumps in diesel injection technology, for coatings on sintered metal friction bearings and pump pistons, high-temperature insulation in the area of exhaust aftertreatment or high-temperature corrosion protection on heat exchangers in heating and air conditioning technology.

The properties of the functional coatings thus produced may be adapted very easily through the choice and amount of functional material added. Suitable functional materials include, depending on application, ceramic or oxidic powders, e.g., Al₂O₃ powder, ZrO₂ powder for thermal insulation, SiC powder, Cr₂O₃ powder for wear protection, metallic powders, e.g., for a targeted adaptation of the thermal expansion coefficient of the functional coating to a substrate, graphite powder or a polymer powder such as polytetrafluoroethylene, polyethylene or polyamide for reducing the coefficient of friction of the functional coating. Finally, suitable additives include SiO₂ powder, TiO₂ powder, TiN powder, Teflon powder, SiN powder, MoS₂ powder, MoSi₂ powder or BN powder. Instead of powders, fibrous materials such as carbon fibers or whiskers may also be used.

Another advantage of the method according to the present invention may be that it is not necessary to provide an adhesive layer between the functional coating and the substrate. To this extent, the method according to the present invention is simpler, faster and less expensive than conventional methods.

Direct use of monoaluminum phosphate in the dispersion or matrix solution produced first may have the advantage over composite sol-gel layers chemically bound with aluminum phosphate that a much higher phosphorus content and thus also a much higher aluminum phosphate content in the resulting layers are feasible. In this manner, a higher hardness and improved wear resistance may be achieved.

To prevent the phosphate such as monoaluminum phosphate, which is present in the dispersion produced first, from precipitating out of the dispersion, it may be advantageous if the dispersion has a pH lower than 4, e.g., lower than 2.5. It may also be advantageous if the amount of phosphoric acid in the matrix solution is between 10 vol % and 40 vol % particularly 15 vol % and 30 vol %.

A phosphoric acid inhibitor or an oxidizing agent may be added to the dispersion or matrix solution thus produced as needed to prevent chemical attacks of phosphoric acid on the substrate from occurring at such a high acid content when certain metal alloys are used as the substrate. In addition, in some cases it may also be advantageous to first passivate the surface of the metal to be coated, e.g., by a conventional phosphating step.

### DETAILED DESCRIPTION

The process begins with a matrix solution including a liquid component and a phosphate in which the at least one functional material is dispersed.

The liquid component is, for example, water or a mixture of water with an organic solvent, e.g., an alcohol or glycol. The functional material is used as a powdered functional material, e.g., having an average particle size of 10 nm to 5 μm, or as a functional material in the form of fibers or whiskers.

Suitable functional materials include a metal, a polymer, graphite, a hard material, a dry lubricant or a ceramic, e.g., silicon carbide, zirconium dioxide, aluminum oxide, silicon dioxide, titanium dioxide, titanium nitride, Teflon, polytetrafluoroethylene, polyethylene, polyamide, boron nitride, silicon nitride, molybdenum disilicide, molybdenum disulfide or chromium oxide.

To produce the phosphate in the matrix solution, phosphoric acid is also added to the matrix solution, the amount of phosphoric acid in the matrix solution is between 10 vol % and 40 vol %, particularly 15 vol % and 30 vol %, and a metal compound is also added, e.g., a compound of the metals aluminum, zirconium, titanium, iron, magnesium or calcium. A phosphate in the matrix solution is formed by chemically dissolving the metal compound, e.g., Al(OH)₃, AlOOH, aluminum triisopropylate, aluminum tri-sec-butylate, aluminum carbonate, zirconium carbonate, Zr(OH)₄ or ZrO₂ in the phosphoric acid.

Moreover, the resulting matrix solution with the liquid component and the phosphate may also be referred to as a gel due to its consistency.

An aluminum compound such as AlOOH or Al(OH)₃ is used as the metal compound so that a monoaluminum phosphate is formed with phosphoric acid. It is important to be sure that the pH of the matrix solution is less than 4, e.g., less than 2.5, so that the phosphate does not precipitate out of the matrix solution.

The above-mentioned functional materials are added to the finished matrix solution, e.g., as a powder, and dispersed in it.

The resulting dispersion is then applied to the substrate to be coated by the conventional coating technique, i.e., by dipping, spraying, flooding, Tampoprint or screen printing, for example.

Then the resulting coating is dried and, depending on the application, fired at temperatures between 150° C. and 800° C., e.g., 200° C. to 400° C. It is important here to be sure that the coated item passes slowly through the temperature range of 120° C. to 180° C. The holding times at the final temperature reached depend on the application and the composition of the layer and are between a few minutes and a few hours, but at higher final temperatures only short holding times are used.

In the heat treatment, the monoaluminum phosphate present in the matrix solution is converted to extremely finely divided aluminum phosphate (AlPO₄) which is then usually in crystalline to nanocrystalline form. At temperatures below 250° C. in the heat treatment, an amorphous aluminum phosphate component may also remain. In addition, the resulting functional coating is often porous, which is a result of the cleavage of water and the conversion of monoaluminum phosphate (Al(H₂PO₄)₃) to aluminum phosphate (AlPO₄) . The porosity usually amounts to 5 vol % to 15 vol %, but values up to 30 vol % are also feasible, the pore radii is significantly less than 1 μm (nanoporosity).

The roughness R_{z} or Rₐ of the functional coating produced is usually less than 8 μm or less than 2 μm, but depends greatly on the functional material used and the coating technique used.

For drying, it is advisable to dry the coating in dry air because the applied coating is hygroscopic due to its relatively high phosphoric acid content.

The dispersion used for coating may also contain other additives in addition to the components mentioned, these additives are pyrolyzed in the heat treatment and consequently are volatilized. These include, for example, wetting agents such as alcohols or organic acids, liquefiers or thickeners such as glycols to adjust the rheological properties of the dispersion or the coating, oxidizing agents such as hydroxylamine or nitrates, e.g., to prevent the formation of hydrogen, phosphorus inhibitors such as cinnamaldehyde thiosemicarbazole or dispersion aids.

The material used for the substrate to be provided with the coating may be, for example, aluminum alloys, diecast aluminum, magnesium alloys, copper alloys, nickel alloys, chromium alloys, high grade steels, tool steels or sintered metals.

If these materials are sensitive to chemical attack by phosphoric acid, the metal surface may also be passivated, e.g., by conventional phosphating and/or by also adding phosphoric acid inhibitors and oxidizing agents to the matrix solution.

The heat treatment at temperatures between 150° C. and 800° C. is conventionally performed in an oven, but it may also be performed locally by surface irradiation of the coating with a laser, an infrared lamp or a UV lamp. This is expedient e.g., when only local heating of the coating is to be achieved on large components or those that are difficult to access or when heating of the coated substrate is to be avoided as much as possible.

Following the heat treatment, the functional coating thus produced may be aftertreated, e.g., by polishing or by subsequent infiltration with graphite or a lubricant, e.g., into a porous structure of the functional coating. This aftertreatment may facilitate implementation of an additional function, e.g., further reducing the coefficient of friction of the functional coating.

The duration of the heat treatment is typically a total of 15 minutes to 10 hours, usually 1 hour to 5 hours.

The heat treatment achieves the result that the matrix solution is at least largely, completely or almost completely converted to a metal phosphate, e.g., aluminum phosphate or zirconium phosphate. Then the functional material added to the dispersion is integrated into this phosphate.

The thickness of the functional coating thus produced on the substrate is between 5 μm and 500 μm, e.g., 10 μm to 50 μm.

It should also be emphasized that the matrix phase thus produced is largely free or completely free of aluminum oxide, e.g., γ-Al₂O₃, following the heat treatment.

With regard to the composition of the dispersion used to produce the coating, the molar ratio between the phosphoric acid and the metal component, e.g., aluminum, dissolved chemically in the matrix solution should be between 2:1 and 6:1, e.g., 3:1 and 3.5:1, based on the metal ion.

The quantity ratio of the substance in the matrix solution to the functional material in the dispersion should be between 1:2 and 1:12, e.g., between 1:6 and 1:9.

The optional phosphoric acid inhibitors are used in a molar ratio of 0 to 1:50, relative to the phosphoric acid used. For the oxidizing agent which is also optional, the molar ratio of oxidizing agent to phosphoric acid is e.g., 0 to 1:10.

What is claimed is:

1. A method of producing a functional coating on a substrate, comprising:
dispersing at least one functional material in a matrix solution including a liquid component and a phosphate, in order to produce a dispersion;
applying the dispersion to the substrate as a coating; and
converting the coating by a heat treatment to the functional coating including an inorganic matrix phase and the at least one functional material integrated into the inorganic matrix phase.

2. The method according to claim 1, wherein:
the liquid component includes one of a water and a mixture of water with an organic solvent; and
the at least one functional material is in the form of one of a powdered material and of one of fibers and whiskers.

3. The method according to claim 2, wherein the organic solvent includes one of alcohol and a glycol.

4. The method according to claim 2, wherein the powdered material has an average particle size of 10 nm to 5 μm.

5. The method according to claim 1, wherein:
the at least one functional material is one of a metal, a polymer, graphite, a hard material, a metal nitride, a metal oxide, a metal carbide, a metal carbonitride, a dry lubricant, and a ceramic.

6. The method according to claim 1, wherein:
the at least one functional material includes one of Si, ZrO₂, Al₂O₃, SiO₂, TiO₂, TiN, Teflon, polytetrafluoroethylene, polyethylene, polyamide, boron nitride, silicon nitride, MoS₂, MoSi₂and chromium oxide.

7. The method according to claim 1, wherein:
the matrix solution is produced by adding phosphoric acid to a metal compound including one of Al, Zr, Ti, Fe, Mg and Ca, and an amount of the phosphoric acid in the matrix solution is between 10 vol % and 40 vol %.

8. The method according to claim 7, wherein the phosphoric acid in the matrix solution is between 15 vol % to 30 vol %.

9. The method according to claim 7, wherein:
one of an aluminum compound and a zirconium compound is dissolved in the phosphoric acid.

10. The method according to claim 7, wherein:
one of an aluminum oxide, a zirconium oxide, an aluminum carbonate, a zirconium carbonate, Al(OH)₃, Zr(OH)₄, AlOOH, aluminum triisopropylate and aluminum tri-sec-butylate is dissolved in the phosphoric acid.

11. The method according to claim 1, wherein:
a pH of the dispersion is at least one of less than 4, and adjusted so that the phosphate is not precipitated in the dispersion.

12. The method according to claim 11, wherein the pH of the dispersion is less than 2.5.

13. The method according to claim 1, wherein:
during the heat treatment, the coating is at least temporarily heated to a temperature between 150° C. and 800° C.

14. The method according to claim 13, wherein the temperature is between 200° C. to 400° C.

15. The method according to claim 1, wherein:
the heat treatment is performed at least one of in an oven and locally by one of surface laser radiation, IR radiation and UV radiation of the coating.

16. The method according to claim 1, further comprising:
drying the coating prior to the heat treatment by dry air, wherein the heat treatment is subsequently performed for a period of 15 minutes to 20 hours.

17. The method according to claim 16, wherein the period is from 1 hour to 5 hours.

18. The method according to claim 1, wherein:
the coating is applied by one of dipping, spraying, flooding, Tampoprint, and screen printing, to one of a metal surface and a ceramic surface used as the substrate.

19. The method according to claim 1, wherein:
the matrix solution is at least substantially converted to a metal phosphate by the heat treatment.

20. The method according to claim 19, wherein:
the metal phosphate includes one of an aluminum phosphate and a zirconium phosphate.

21. The method according to claim 1, further comprising:
adding at least one of a wetting agent, a liquefier, a thickener, an oxidizing agent, a phosphoric-acid inhibitor and a dispersant to the matrix solution prior to coating of the substrate.

22. The method according to claim 1, further comprising:
at least one of polishing and infiltrating, after the heat treatment, the functional coating with another functional material.

23. The method according to claim 22, wherein the other functional material includes one of a graphite and a lubricant.

24. The method according to claim 7, wherein:
a molar ratio of the phosphoric acid to metal ions of the metal compound in the matrix solution is between 2:1 and 6:1, in particular between 3:1 and 3.5:1.

25. The method according to claim 1, wherein:
a substance-amount ratio of the matrix solution to the functional material in the dispersion is between 1:2 and 1:12.

26. The method according to claim 25, wherein the substance amount ratio is between 1:6 and 1:9.

27. A functional coating on a substrate, produced in accordance with a method including:
dispersing at least one functional material in a matrix solution including a liquid component and a phosphate, in order to produce a dispersion;
applying the dispersion to the substrate in the form of a coating; and
converting the coating by a heat treatment to the functional coating including an inorganic matrix phase and the at least one functional material integrated into the inorganic matrix phase, wherein:
the inorganic matrix phase is at least largely made of a phosphate.

28. The functional coating according to claim 27, wherein:
the phosphate is one of an aluminum phosphate and a zirconium phosphate.

29. The functional coating according to claim 27, wherein:
the inorganic matrix phase is at least largely free of Al₂O₃.

30. The functional coating according to claim 27, wherein:
the inorganic matrix phase is at least largely free of γ-Al₂O₃.
